(19) United States
(12) Patent Application Publication
(10) Pub. No.: US 2019/0366847 A1
(43) Pub. Date: Dec. 5, 2019

(54) LIGHTING SYSTEM AND LIGHT SOURCE ASSEMBLY FOR USE WITH NIGHT VISION EQUIPMENT

(71) Applicant: General Electric Company, Schenectady, NY (US)

(72) Inventor: Mark Marshall Meyers, Halfmoon, NY (US)

(21) Appl. No.: 16/543,121

(22) Filed: Aug. 16, 2019

Related U.S. Application Data
(63) Continuation of application No. 15/399,078, filed on Jan. 5, 2017, now abandoned.
(60) Provisional application No. 62/298,612, filed on Feb. 23, 2016.

(51) Int. Cl. B60K 35/00; C09K 11/61

(52) U.S. Cl. CPC B60K 35/00; G02F 2001/133614; C09K 11/617

(57) ABSTRACT

A light source assembly for use in a display device used in conjunction with night vision gear is provided. The light source assembly includes a light emitting diode configured to generate light comprising visible light and does not emit near IR light. A phosphor body configured to absorb the blue light and emit white light which does not contain near IR. The phosphor body prevents near IR light c from saturating the night vision gear.

### CROSS-REFERENCE TO RELATED APPLICATIONS

This application is a continuation of U.S. application Ser. No. 15/399,078, filed Jan. 5, 2017, which claims priority to U.S. Provisional Application No. 62/298,612, filed 23 Feb. 2016, the entire disclosure of which is incorporated herein by reference.

### BACKGROUND

Displays are widely used to allow for the conversion of electrical signals into images. Such images are typically in color wherein the photoluminescence materials generate a light signal in response to radiation excitation from a backlight. The visible region of the electromagnetic spectrum that is viewable by the naked eye ranges from about 400 nanometers (nm) to about 700 nm.

Liquid crystal displays (LCDs) are widely used to provide the displays in many applications. The LCD is typically formed from an array of pixels formed from individual liquid crystal cells. For a color LCD, each pixel contains three sub-pixels comprised of red, green and blue. By varying the intensity of these RGB sub-pixels and through the use of color filter, the color images are displayed.

Light emitting diodes (LEDs) are another display technology that uses a pn-junction diode to emit light when activated through electroluminescence. The color of the light corresponds to the energy of photon in accordance with the energy band gap of the semiconductor material. Since its discovery and implementation in the 1960's, LEDs have experienced significant advancements and expansion into various lighting applications.

LEDs employs various phosphors to provide white light to the LCD display backlight. LEDs are available in wavelengths that include visible, ultraviolet and infrared with varying levels of brightness and energy consumption depending upon design criteria. The LEDs typically emit light in a narrow spectrum (e.g., 20 to 30 nm full width at half maximum, or FWHM) if the LEDS are not used with a phosphor to extend the wavelength emission range of the LEDs. Most white LEDs are blue emitting LEDs with a phosphor coating that absorbs blue light and emits yellow and red light. One particular implementation of LED displays is for backlit LCD displays. Conventional systems for backlighting displays are typically designed for brightness and contrast for daylight conditions.

One application of such displays is for use in darkened or dimly lit environments where night vision gear is deployed. The brightness of the conventional display negatively interferes with the night vision equipment and may also cause eye discomfort to the user. Typical LCD displays emit light from the blue to the red end of the spectrum. Light emitted by the display in the red end of the spectrum from 650 to 900 nm will interfere with the operation of night vision equipment, since the night vision equipment is sensitive to those wavelengths. If the night vision equipment is used when such displays are active, the night vision equipment will bloom, or display an all white image, independent of the outside scene.

Night vision equipment is used in a variety of applications such as for military, law enforcement, and emergency situations as well as recreational applications such as animal watching and hunting. Some examples include vehicle operation where night vision gear is worn to see the external environment and where the instrument displays also need to be viewed. Such vehicles include aircraft, helicopters, tanks, trains, and ships. Night vision goggles and night vision imaging systems heads-up displays are examples of viewing devices that are used for night vision usage.

In a conventional implementation, the night vision equipment amplifies the red and near infrared (near-IR) light and projects this light on a green phosphor display. The current generation of night vision goggles enhances visibility to the level necessary for night time operations through increased sensitivity in the red and near IR spectrums from approximately 630 nm to 930 nm.

One of the important uses of night vision gear relates to defense vehicles. For example, during nighttime operations on a plane, train, ship or helicopter, the user has instrument displays that are used in the operation of the vehicles, but also requires night vision equipment to identify location and targets. In certain examples the instrumentation tends to interfere with the night vision equipment as both emit significant energy in the infrared (IR) region.

Unfortunately, the instrument display emits IR radiation that causes problems with night vision equipment. Such displays tend to emit light in the near-IR in the range from approximately 650 to 1000 nm at sufficient energy levels to interfere with the night vision usage. For example, IR interference can cause night vision goggles to become unusable due to blooming, ghosting, and general equipment sensitivity loss.

The illumination of some cockpit displays generates enough energy in the night vision goggle response spectrum to saturate the display, thereby rendering the whole scene bright white. The U.S. government has established specifications such as MIL-L-85762A with requirements for NVIS compatible aircraft interior lighting. There are two general types of night vision goggles per MIL-L-85762A, namely Type I and Type II, with comparable response spectrum and sensitivity. The Type I NVIS system uses Generation III image intensifier tubes to display the image on a phosphor screen in the users direct line of sight, whereas the Type II NVIS projects the image on a transparent medium in the users line of sight (similar to standard heads-up display technology). The Type II configuration allows for simultaneous viewing of the intensified image and the cockpit displays. The Type I goggle user must look below the goggles' display in order to use the control instruments.

One conventional solution is to filter the avionics display so that the display emits the necessary light for proper operation in both day and night environments while attenuating levels of the respective far red and near-IR radiation. The typical Type I and Type II goggles are equipped with a minus blue filter for heavy suppression of the visual spectrum before the radiation can reach image intensifier tubes. There are two minus blue filters available (Class A and Class B)—long pass filters with a Tp at 625 nm and 665 nm, respectively. The Class B filter lets less of the visual red spectrum pass; therefore, Class B NVIS is compatible with red cockpit lighting and the Class A systems have a spectrum overlap and cannot be used with the NVIS red lighting. The filters are designed for the specific application and more general applications are not supported.

Various implementations have been considered for providing backlit displays with low intensity levels that allow for use of night vision equipment. According to one example, the light sources were specifically designed solely with low intensity sources and only used in dark environments. This limits the usefulness of the display since the display does not have adequate brightness for a user in daytime use or when night vision gear is not being used. Other applications use white LEDs and LCD pixels patterned with red green and blue color filters. Some known systems use filter screens that are placed over the display and to filter out the far red and near infrared (NIR) light and reduce this light to a level that is acceptable with the night vision gear. Adding a separate filter to take out the red and NIR to a display in an aviation application adds weight, increases the display cost, reduces brightness of the display, and reduces contrast of the display.

Additionally, the electronics continues to output the same intensity level even though the light is filtered and represents a loss of efficiency. This also consumes more power and generates heat that has to be dissipated.

### BRIEF DESCRIPTION

In one embodiment, a light source assembly for use in a display device used in conjunction with night vision gear is provided. The light source assembly includes a light emitting diode configured to generate light comprising one or more wavelengths in a blue spectral region and a phosphor body configured to absorb the blue light. The phosphor body avoids saturating the night vision gear by not emitting light with wavelengths longer than 650 nm.

In one embodiment, a lighting system includes a display device configured to emit light to visually represent information to an operator without causing a decrease in visibility through night vision goggles. The display device includes a light emitting diode configured to generate the light without emitting the light in a near-infrared (IR) range of light and a phosphor body configured to absorb a blue light portion of the light generated by the light emitting diode. The phosphor body does not emit light at wavelengths in the near-IR range of light which would saturate the night vision goggles.

### BRIEF DESCRIPTION OF THE DRAWINGS

The subject matter described herein will be better understood from reading the following description of non-limiting embodiments, with reference to the attached drawings, wherein below:

FIG. 1 illustrates one example of display devices that may be used onboard one or more vehicles;

FIG. 2 illustrates a perspective view of an operator using night vision gear to view objects during low-light conditions according to one example;

FIG. 3 is a top view of an LED backlight device;

FIG. 4 is a schematic diagram of an LCD display device that includes the LED backlight device shown in FIG. 3;

FIG. 5 illustrates one embodiment of a light source assembly;

FIG. 6 illustrates spectra of different light sources according to different examples;

FIG. 7 illustrates an intensity spectrum of light generated by a cathode fluorescent lamp (CCFL) according to one example;

FIG. 8 illustrates an intensity spectrum of light generated by a white LED and a PFS phosphor shown in FIG. 5 according to one example; and

FIG. 9 illustrates a flowchart of one embodiment of a method for improving operation of night vision gear.

### DETAILED DESCRIPTION

Example embodiments are described below in detail with reference to the accompanying drawings, where the same reference numerals denote the same parts throughout the drawings. Some of these embodiments may address the above and other needs.

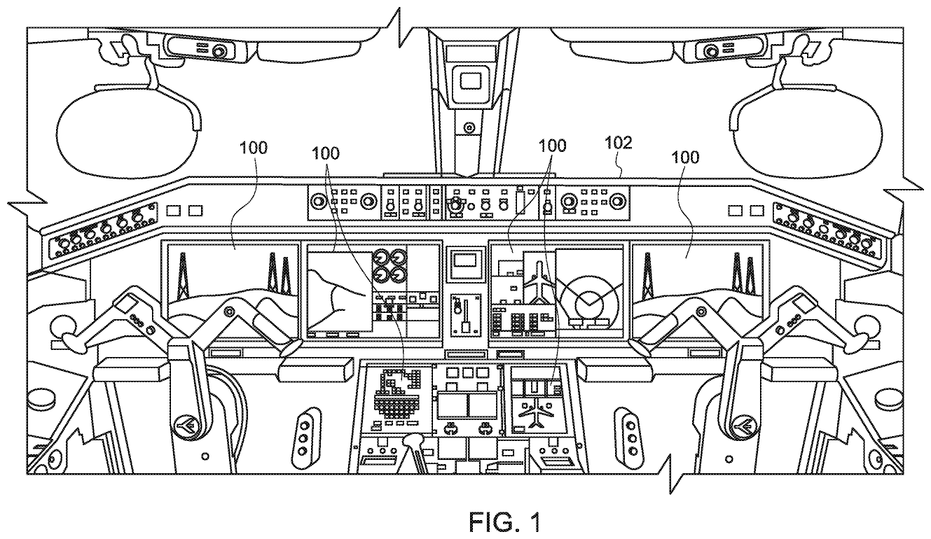

FIG. 1 illustrates one example of display devices 100 that may be used onboard one or more vehicles 102. The display devices 100 can represent LCD displays, LED displays, or other types of monitors that generate light to represent information that is visually conveyed to one or more operators of the vehicle 102. These display devices 100 can be disposed in a cockpit or vehicle display to provide visual indicators representative of operating characteristics of the vehicle 102, geographic information, travel information, armament details, and similar information based on the system and applications. The vehicle 102 in this example is an aircraft, however similar displays are used on other types of vehicles 102, such as helicopters, tanks, ships, and trains.

In daytime operations, the operator of the vehicle 102 may view the displays in order to ensure safe operations and mission success. During operation in reduced visibility, such as nighttime, smoke, fog, adverse weather, and similar conditions, however, the operator may not be able to see objects outside of the vehicle 102 but may still be able to view the information presented on the light-generating display devices 100.

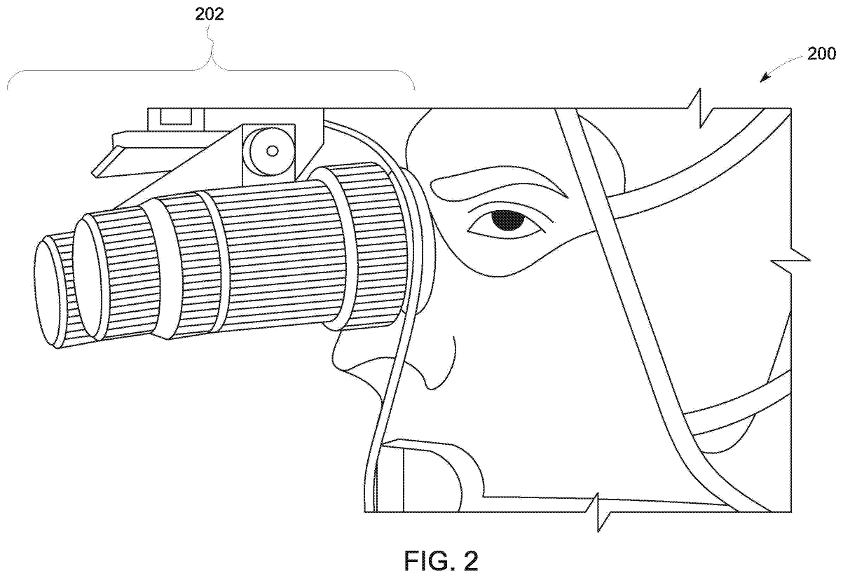

FIG. 2 illustrates a perspective view of an operator 200 using night vision gear 202 to view objects during low-light conditions according to one example. The night vision gear 202 can represent night vision goggles or other equipment that collect and amplify low levels of light so that the operator 200 can view objects in the low-light conditions. The night vision gear 202 may be deployed as headgear to permit the operator 200 to see despite the limited light conditions. In one example, the operator 200 may need to see the terrain or external environment and the night vision gear 202 enables such visibility. The operator 200 may need to simultaneously see the external environment as well as the display devices 100. In order to properly see the external environment and also the display devices 100, the light emissions from the display devices 100 must not interfere with the night vision gear 202 functionality.

The light emitted from some display devices, such as LCD displays, can extend into the near-IR, or NIR, range of wavelengths. This spectral emission can include wavelengths that are at least 700 nm and no more than 1000 nm in one embodiment. Light having a wavelength within this range can interfere with night vision gear 202, such as by saturating the gear 202 and thereby preventing the operator 200 from being able to see with the gear 202.

In accordance with one embodiment of the inventive subject matter, methods and systems for LED backlight for night vision compatible avionics displays are provided. Display devices 100 utilized in vehicles such as military aircraft 102 will be more useful if the display devices 100 can be utilized in both daylight operating conditions and at nighttime with night vision gear 202. Night vision gear 202 captures IR light emitted by other aircraft, military vehicles, other vehicles, and humans. This ability allows pilots and crew to operate in total darkness, since these operators 200 can view the IR emission from warm bodies. If the display devices 100 used in the vehicle 102 emit light in the near-IR spectrum (e.g., 700 to 1000 nm), however, the display devices 100 will cause blooming, or saturation of the night vision gear 202, rendering the gear 202 useless for seeing in the IR.

One embodiment of the inventive subject matter described herein can include one or more display devices 100 that include an LED backlight, where the LED backlight has reduced emission in the near-IR portion of the spectrum of light. This reduced emission enables the display device 100 to be compatible with night vision gear 202 at night, while avoiding blooming or saturating the goggles, and also be bright enough to be fully functional during the daytime.

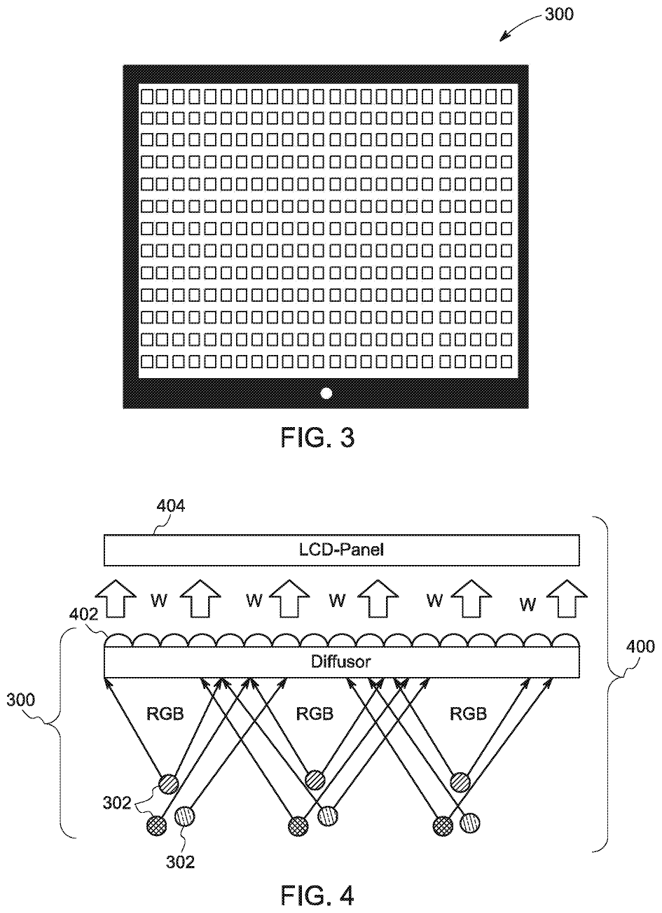

FIG. 3 is a top view of an LED backlight device 300. FIG. 4 is a schematic diagram of an LCD display device 400 that includes the LED backlight device 300. The backlight device 300 includes several light sources 302, such as LEDs, that emit light. An LCD display device 400 can include arrays of electrically controlled liquid crystal shutters between a pair of glass plates, which is coupled to a diffusor plate 402 such that light generated in the backlight device 300 can be transmitted to an observer. The LEDs 302 may be blue LEDs, which emit light in the 450 to 475 nm wavelength range (referred to herein as a blue spectral region) with a phosphor deposited over the top of the blue LEDs 302. The phosphor absorbs some of the blue light, and re-emits the absorbed light as red or green light. The remainder of the blue light (e.g., the light that is not absorbed) is transmitted to a visible panel 404 of the LCD display device 400. The light emitted by the LEDs 302 and phosphors includes blue light emitted by the LED 302, along with green and red light generated by a Stokes shifted emission from the phosphor. The red light emitted from standard, nitride-based phosphors includes light emissions in the near-IR range that would cause blooming in night vision gear 202.

One embodiment of the inventive subject matter described herein includes white LEDs that eliminate light emissions from a display in the near-IR range of the spectrum of wavelengths of light. This is accomplished by using phosphors which replace known nitride-based red phosphors with a potassium fluorosilicate-based phosphor that has been doped with manganese (referred to as PFS phosphor).

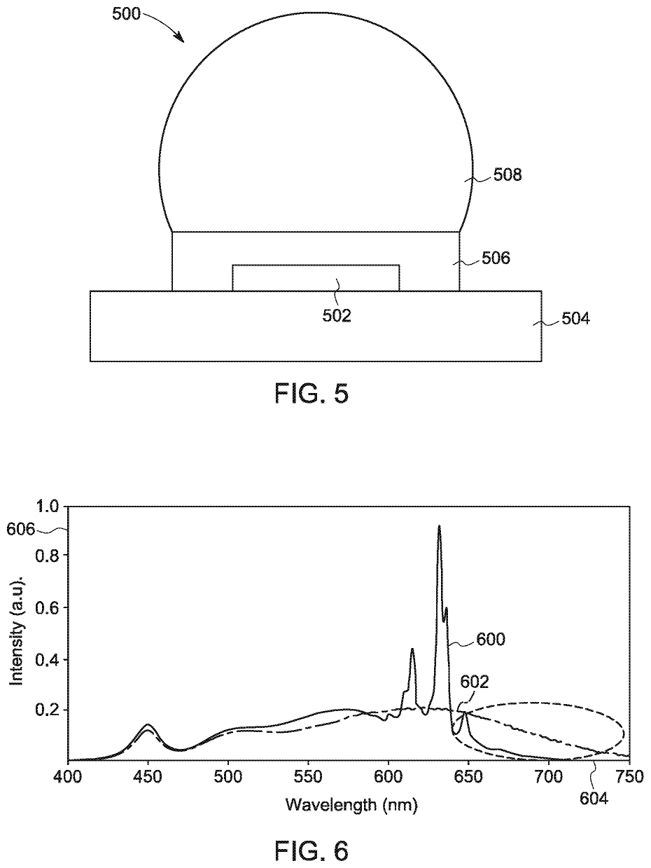

FIG. 5 illustrates one embodiment of a light source assembly 500. The light source assembly 500 can represent an LED that can be used to eliminate or reduce light emissions from a display device 100 that includes the light source assembly 500 (or several light source assemblies 500) that are within the near-IR range of wavelengths. The light source assembly 500 includes one or more light sources 502 (e.g., LEDs) connected on the same or different substrates 504, such as circuit boards. A phosphor body 506 may be disposed on the light source 502 such that at least some of the light generated by the light source 502 is absorbed by the phosphor 506. Other portions of this light generated by the light source 506 may pass through the phosphor 506 without being absorbed. The phosphor 506 may be a coating applied onto the light source 502, a body that is coupled with the light source 502, or another type of body. A lens 508 optionally may be disposed on the phosphor 506 to focus, collimate, or otherwise direct the light emitted from the phosphor 506.

In contrast to some known display devices, the light sources 502 used in the display devices 100 may emit white light. For example, some known LCD display devices use blue-light LEDs (e.g., LEDs emitting light with wavelengths of 450 to 475 nm), as described above. The LEDs used as the light sources 502 in the display devices 100 may emit white light. In contrast to the nitride phosphors used is some known LCD display devices, the phosphor 506 may be a PFS red phosphor and not a nitride-based red phosphor (also referred to as a broad red phosphor). The phosphor 506 may be radiationally coupled to the light source 502 in that the phosphor 506 is positioned to receive the light generated by and emanating from the light source 502. In one embodiment, the phosphor 506 may be radiationally coupled with the light source 502 by directly abutting the light source 502. Alternatively, the phosphor 506 may be radiationally coupled with the light source 502 even if the phosphor 506 is spatially separated from the light source 502.

The phosphor 506 can eliminate or reduce the amount (e.g., intensity) of light in the near-IR range of wavelengths from being emitted from the phosphor 506. The phosphor 506 can absorb all or substantially all (e.g., at least 99%, at least 98%, at least 95%, or another amount) of the light in the near-IR range that is emitted by the light source 502. The combination of the white light LED 502 and the PFS phosphor 506 can eliminate or reduce the light emitted by the display devices 100 in the near-IR range of wavelengths. The light source 502 may not include any IR absorbing material. For example, the light source 502 may not include an IR filter, a coating or lens that absorbs IR wavelengths of light (other than the phosphor 506), etc.

The white LEDs 502 with the PFS red phosphor 506 may generate increased intensities of red light at shorter wavelengths and minimal or no near-IR emissions of light. The white LEDs 502 can help reduce the amount of light that is generated with wavelengths greater than 660 nm. The PFS phosphor 506 can provide for a better color gamut and brighter reds with the LCD display devices 100.

FIG. 6 illustrates spectra 600, 602 of different light sources according to different examples. The spectrum 600 represents the intensities of light emitted from the light source 502 coupled with the PFS phosphor 506 and the spectrum 602 represents the intensities of light emitted from the same type of light source 502 with a nitride-based red phosphor. The spectra 600, 602 are shown alongside a horizontal axis 604 representative of wavelengths of emitted light (expressed in nm) and a vertical axis 606 representative of intensities of light (expressed in atomic units).

As shown in FIG. 6, the intensities of the light in the near-IR range of wavelengths (e.g., 700 to 1000 nm) in the spectrum 600 of light emitted from the white LEDs 502 with the PFS red phosphor 506 are substantially less than the intensities of the light in this same range emitted by the white LEDs with a nitride-based red phosphor (i.e., the spectrum 602). The white LEDs 502 may generate light having wavelengths in the near-IR range, but the PFS phosphors 506 can absorb these wavelengths to prevent the wavelengths of light in the near-IR range from emanating from the light source assemblies 500. The intensities of the light generated by the LED with the nitride-based phosphor can cause saturation and blooming of the night vision gear 202, while the low or non-existent intensities of the light generated by the white LEDs 502 with the PFS phosphor 506 avoid this saturation and blooming. As a result, the operator 200 is able to use the night vision gear 202 in the presence of light generated by the display devices 100.

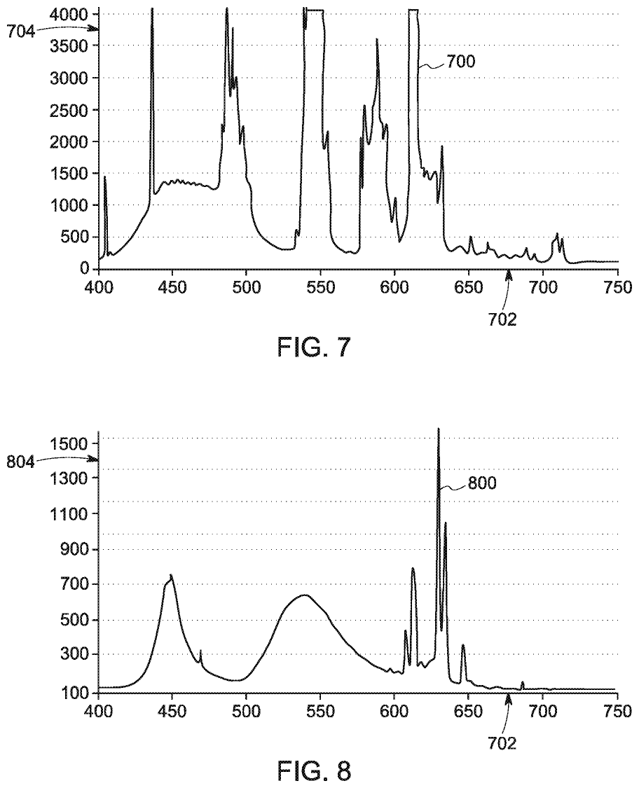

FIG. 7 illustrates an intensity spectrum 700 of light generated by a cathode fluorescent lamp (CCFL) according to one example. The spectrum 700 is shown alongside a horizontal axis 702 representative of different wavelengths of light and a vertical axis 704 representative of different intensities of the various wavelengths of the light. The units of the horizontal axis 702 are nm while the units of the vertical axis 704 are photon counts. A CCFL may be used as a light source in some known display devices. The CCFL may be used to cause the display devices to be illuminated to visually present information to an operator 200. As shown in FIG. 7, however, the light generated by the CCFL has intensities at wavelengths in the near-IR range of wavelengths (e.g., at least 700 nm in FIG. 7). This indicates that the light generated by the CCFL will cause the display devices that include the CCFL to saturate night vision gear 202 and prevent an operator 200 using the gear 202 from being able to see objects in low visibility situations.

FIG. 8 illustrates an intensity spectrum 800 of light generated by the white LED 502 and the PFS phosphor 506 according to one example. The spectrum 800 is shown alongside the horizontal axis 702 and a vertical axis 804 representative of different intensities of the various wavelengths of the light. The units of the vertical axis 804 are relative intensity (lumninance cd/m\hat{ }2). As shown by a comparison of the vertical axes 704, 804 in FIGS. 7 and 8, the spectrum 800 of light generated by the LED 502 and PFS phosphor 506 has significantly lower intensities across the entire range of wavelengths shown in the spectra 700, 800, including in the near-IR range of wavelengths. Additionally, the light generated by the white LED 502 and PFS phosphor 506 has little to no intensity at wavelengths in the near-IR range of wavelengths (e.g., at least 700 nm in FIG. 8). This indicates that the light generated by the white LED 502 and PFS phosphor 506 will not cause the display devices 100 that include the LED 502 and PFS phosphor 506 to saturate night vision gear 202 and prevent an operator 200 using the gear 202 from being able to see objects in low visibility situations. As a result, the night vision gear 202 can continue to be used inside a cockpit of the vehicle 102 at the same time that the display devices 100 at least partially illuminate the interior of the vehicle 102.

Some night vision gear includes additional filters to reduce the light emitted by display devices in the near-IR range. These filters are an additional cost to the night vision gear, add complexity and weight to the night vision gear, and add another potential source of failure for the night vision gear. Additionally, having a filter added to the night vision gear also can reduce the contrast of the display devices 100 as seen by the operators 200 due to secondary reflections from the filter glass. The white LEDs 502 with PFS phosphors 506 as described herein can reduce the near-IR light received by the night vision gear 202 to avoid saturation or blooming of the gear 202 without the need for additional equipment such as these filters.

Additionally, the display devices 100 that include the white LEDs 502 and PFS phosphors 506 may consume less power than other display devices that do not include the white LEDs or that do not include the PFS phosphors 506. Because more of the light emitted by the LEDs 502 in the near-IR range is filtered due to the PFS phosphor 506, less electric power is needed to power the LEDs 502. The reduced power consumption also may decrease the amount of heat generated by the display devices 100.

A lighting system may include one or more night vision gear 202 and one or more of the display devices 100 that include the white LEDs 502 with the PFS phosphors 506. A method for providing a lighting system may include coupling the PFS phosphors 506 with the white LEDs 502 to form one or more light source assemblies 500 that are used in one or more display devices 100. The method also can include filtering light in the near-IR portion of the spectrum of wavelengths of light generated by the white LEDs 502 in order to reduce or eliminate emanation of the near-IR wavelengths of light out of the display devices. This can reduce saturation and/or blooming of night vision gear 202 such as night vision goggles.

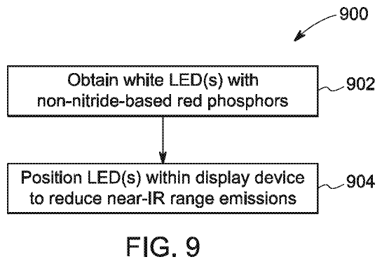

FIG. 9 illustrates a flowchart of one embodiment of a method 900 for improving operation of night vision gear. The method 900 may be used to reduce the amount of blooming or saturation that occurs with night vision gear relative to using other methods with night vision gear. At 902, one or more white LEDs having non-nitride-based red phosphors are obtained. These LEDs may have potassium fluorosilicate-based phosphors that are doped with manganese, such as tetravalent manganese (Mg⁴⁺). At 904, the one or more white LEDs are positioned within a display device. For example, the PFS-based LEDs can be included in a display device used in an environment where night vision gear may be used. The white LEDs are included in the display device such that the white LEDs operate to backlight or otherwise illuminate the display device while eliminating or reducing the amount (e.g., intensity) of light in the near-IR range of wavelengths from being emitted from the phosphors of the LEDs (e.g., relative to non-white LEDs and/or LEDs operating with different phosphors). As described above, the PFS-based phosphor can absorb all or substantially all (e.g., at least 99%, at least 98%, at least 95%, or another amount) of the light in the near-IR range that is emitted by the display device.

In one embodiment, a light source assembly for use in a display device used in conjunction with night vision gear is provided. The light source assembly includes a light emitting diode configured to generate light comprising one or more wavelengths in a blue spectral region and a phosphor body configured to absorb the blue light. The phosphor body avoids saturating the night vision gear by not emitting light with wavelengths longer than 650 nm.

In one example, the display device that includes the light source assembly is a liquid crystal display (LCD) device. The display device that includes the light source assembly can be located onboard a vehicle operated by an operator using the night vision gear.

The light emitting diode can be a white light emitting diode that generates white light that includes the one or more wavelengths in the visible spectrum of light, but does not emit light in a near IR range. The near-IR range of light may include the wavelengths of light that are at least 700 nanometers. Optionally, the near-IR range of light can include the wavelengths of light that are no more than 1000 nanometers. In one example, the near-IR range of light can include the wavelengths of light that are at least 700 nanometers and no more than 1000 nanometers.

The phosphor body can include a potassium fluorosilicate-based phosphor. The phosphor body may include a potassium fluorosilicate-based polymer doped with manganese. In one example, the phosphor body does not include a nitride.

In one embodiment, a lighting system includes a display device configured to emit light to visually represent information to an operator without causing a decrease in visibility through night vision goggles. The display device includes a light emitting diode configured to generate the light without emitting the light in a near-infrared (IR) range of light and a phosphor body configured to absorb a blue light portion of the light generated by the light emitting diode. The phosphor body does not emit light at wavelengths in the near-IR range of light which would saturate the night vision goggles.

The display device that includes the light source assembly can be a liquid crystal display (LCD) device. The display device that includes the light source assembly can be located onboard a vehicle operated by an operator using the night vision gear.

The light emitting diode may be a white light emitting diode that generates white light that does not near-IR range of light. The near-IR range of light can include the wavelengths of light that are at least 700 nanometers. Optionally, the near-IR range of light includes the wavelengths of light that are no more than 1000 nanometers. In one example, the near-IR range of light includes the wavelengths of light that are at least 700 nanometers and no more than 1000 nanometers.

The phosphor body may include a potassium fluorosilicate-based phosphor. Optionally, the phosphor body may include a potassium fluorosilicate-based polymer doped with manganese. The phosphor body may not include a nitride.

The display device and the night vision gear can be disposed onboard a vehicle to permit the operator to view the information visually presented on the display device while wearing the night vision gear during operation of the vehicle.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A light source assembly for use in a display device used in conjunction with night vision gear, the light source assembly comprising:
a light emitting diode configured to generate light comprising one or more wavelengths in a blue spectral region; and
a phosphor body configured to absorb the blue light,
wherein the phosphor body avoids saturating the night vision gear by not emitting light with wavelengths longer than 650 nm.

2. The light source assembly of claim 1, wherein the display device that includes the light source assembly is a liquid crystal display (LCD) device.

3. The light source assembly of claim 1, wherein the display device that includes the light source assembly is located onboard a vehicle operated by an operator using the night vision gear.

4. The light source assembly of claim 1, wherein the light emitting diode is a white light emitting diode that generates white light that includes the one or more wavelengths in the visible spectrum of light, but does not emit light in a near IR range.

5. The light source assembly of claim 4, wherein the near-IR range of light includes the wavelengths of light that are at least 700 nanometers.

6. The light source assembly of claim 4, wherein the near-IR range of light includes the wavelengths of light that are no more than 1000 nanometers.

7. The light source assembly of claim 4, wherein the near-IR range of light includes the wavelengths of light that are at least 700 nanometers and no more than 1000 nanometers.

8. The light source assembly of claim 1, wherein the phosphor body includes a potassium fluorosilicate-based phosphor.

9. The light source assembly of claim 1, wherein the phosphor body includes a potassium fluorosilicate-based polymer doped with manganese.

10. The light source assembly of claim 1, wherein the phosphor body does not include a nitride.

11. A lighting system comprising
a display device configured to emit light to visually represent information to an operator without causing a decrease in visibility through night vision goggles,
wherein the display device includes a light emitting diode configured to generate the light without emitting the light in a near-infrared (IR) range of light and a phosphor body configured to absorb a blue light portion of the light generated by the light emitting diode,
wherein the phosphor body does not emit light at wavelengths in the near-IR range of light which would saturate the night vision goggles.

12. The lighting system of claim 11, wherein the display device that includes the light source assembly is a liquid crystal display (LCD) device.

13. The lighting system of claim 11, wherein the display device that includes the light source assembly is located onboard a vehicle operated by an operator using the night vision gear.

14. The lighting system of claim 11, wherein the light emitting diode is a white light emitting diode that generates white light that does not near-IR range of light.

15. The lighting system of claim 14, wherein the near-IR range of light includes the wavelengths of light that are at least 700 nanometers.

16. The lighting system of claim 14, wherein the near-IR range of light includes the wavelengths of light that are no more than 1000 nanometers.

17. The lighting system of claim 14, wherein the near-IR range of light includes the wavelengths of light that are at least 700 nanometers and no more than 1000 nanometers.

18. The lighting system of claim 11, wherein the phosphor body includes a potassium fluorosilicate-based phosphor.

19. The lighting system of claim 11, wherein the phosphor body includes a potassium fluorosilicate-based polymer doped with manganese.

20. The lighting system of claim 11, wherein the phosphor body does not include a nitride.
